(19) United States
(12) Patent Application Publication
(10) Pub. No.: US 2024/0189793 A1
(43) Pub. Date: Jun. 13, 2024

(54) DEVICE AND METHOD FOR INFLUENCING THE FLOW OF A FLOWABLE MEDIUM THROUGH ENERGY INTENSITY ZONES

(71) Applicant: DR. HIELSCHER GMBH, Teltow (DE)

(72) Inventors: Thomas HIELSCHER, Potsdam (DE); Holger HIELSCHER, Rangsdorf (DE); Harald HIELSCHER, Stahnsdorf (DE)

(73) Assignee: DR. HIELSCHER GMBH, Teltow (DE)

(21) Appl. No.: 18/287,062

(22) PCT Filed: May 20, 2022
(86) PCT No.: PCT/EP2022/063685

§ 371 Date: Oct. 16, 2023

(30) Foreign Application Priority Data
Jul. 22, 2021 (DE) 10 2021 119 028.2

(51) Int. Cl. B01J 19/10; B01J 19/00; B01J 19/24

(52) U.S. Cl. CPC B01J 19/10; B01J 19/006; B01J 19/248; B01J 2219/00768; B01J 2219/00772; B01J 2219/0869

(57) ABSTRACT

A device and a method for influencing the flow of a flowable medium through a flow-through reactor are described. The flow-through reactor has at least one inlet opening and at least one outlet opening, through each of which a flowable medium can flow in or out. By means of at least one energy source for changing at least one property of the flowable medium flowing through the flow-through reactor, energy can be introduced whose intensity is non-uniformly distributed in the volume of the flow-through reactor. According to the invention, the flow of the flowable medium flowing through the flow-through reactor is influenced by at least one mechanical component positioned in the flow-through reactor in such a way that a majority of the flowable medium flowing through the flow-through reactor flows through the zones of high energy intensity generated by means of the energy source.

The invention relates to a device and a method for influencing the flow of a flowable medium by energy intensity zones.

Energy, can be e.g. mechanical energy, electrical energy, thermal energy or radiation, preferably mechanical energy.

A flow-through reactor (also called a reactor vessel, flow-through cell, or reactor) is a vessel that has at least one inlet opening, preferably exactly one inlet opening, through which a flowable medium can flow into the flow-through reactor, and at least one outlet opening, preferably exactly one outlet opening, through which a flowable medium can flow out of the flow-through reactor.

The outer profile of the flow-through reactor may be round, oval, cylindrical, funnel-shaped, kettle-shaped, cuboid rectangular or polygonal, preferably cylindrical or funnel-shaped. The outer profile may be rigid or resilient, preferably rigid. The outer profile may be made of metal, plastic, glass, ceramic, composite materials, or any combination thereof, preferably metal, e.g., stainless steel, among others.

According to the invention, energy, preferably mechanical energy, e.g. in the form of mechanical vibrations, is introduced into the flow-through reactor by means of an energy source set up to change at least one property of the flowable medium flowing through the flow-through reactor, which energy preferably generates cavitation in the flowable medium located in the flow-through reactor. The energy introduced into the flow-through reactor causes a change in at least one property, preferably temperature, density, homogeneity, cellular constituent structure, chemical composition, particle size distribution, specific particle surface area, dissolved gas content, viscosity, and/or consistency, e.g., consistency of the flowable medium located in the flow-through reactor. Preferably, in a flow-through reactor having an inlet opening and an outlet opening, the introduction of mechanical energy in the form of low frequency power ultrasound causes a change in the particle size distribution in the flowable medium flowing therethrough by means of cavitation induced by the mechanical energy.

Low frequency power ultrasound (NFLUS) is ultrasound with an operating frequency of 15 to 100 kHz, preferably 15 to 60 kHz, e.g. 20 kHz, and an acoustic power above 5 W, preferably 10 W to 32000 W, e.g. 4000 W. Piezoelectric or magnetostrictive systems, for example, are used to generate the ultrasound. Linear acoustic transducers and flat or curved plate transducers, flexural oscillators or tube resonators are known. Low-frequency power ultrasound has a wide application in the treatment of flowable media (hereafter summarized as medium or media), such as fluids, liquids, dispersions, emulsions, cell suspensions, pastes, paints, slurries, foams, or nanomaterials. These media can have different viscosities from 0 centipoise to 3*10¹⁰ centipoise, preferably from 0.1 centipoise to 1*10⁶ centipoise. The viscosity and material composition can vary greatly in the media stream.

For the introduction of mechanical energy in the form of mechanical vibrations, e.g. NFLUS is transmitted directly or indirectly to the medium via a resonator with amplitudes of 1 to 350 micrometers, preferably 5 to 50 micrometers, e.g. 40 micrometers. Lambda is the wavelength which results from the NFLUS frequency and the sound propagation velocity in the resonator. A resonator can consist of one or more lambda/2 elements. A resonator consisting of several lambda/2 elements can be manufactured from a piece of material of corresponding length or can be assembled from several elements of length n*lambda/2 (n∈N), e.g. by screwing, welding, gluing or pressing. Lambda/2 elements can have different material cross-sectional geometries, e.g. circular, oval or rectangular cross-sections. The cross-sectional geometry and area can vary along the longitudinal axis of a lambda/2 element. Lambda/2 elements can be made of, among other things, metallic or ceramic materials or glass, in particular titanium, titanium alloys, steel or steel alloys, aluminum or aluminum alloys, e.g., titanium grade 5. Lambda/2 elements can be, for example, solid or hollow, preferably solid.

Depending on the requirements of the respective application objective, the flowable medium in a flow-through reactor can be under a lower or a higher pressure than the ambient pressure. A lower pressure (negative pressure) is present between vacuum (0 bar absolute) and ambient pressure (e.g. 1 bar absolute), e.g. at 0.5 bar. A higher pressure (overpressure) exists when the pressure is higher than the ambient pressure. Some systems use a flow-through reactor internal pressure between 1.5 bar absolute to 1000 bar absolute, preferably between 2 bar and 40 bar, e.g. 4 bar absolute.

To introduce NFLUS into such a flow-through reactor, either the flow-through reactor wall can be vibrated by an externally mounted NFLUS system, or an NFLUS acoustic transducer can be installed entirely within the pressurized inner space of the flow-through reactor. Alternatively, the acoustic transducer, e.g. a piezoelectric linear acoustic transducer, can be located outside the flow-through reactor and the vibrations can be guided into the inner space of the flow-through reactor via one or more resonators.

To introduce NFLUS into a flow-through reactor from the outside, vibrations can be transmitted to the flow-through reactor contents via the flow-through reactor wall. The vibration transmission to the flow-through reactor wall can be all-round, enclosing, over the entire flow-through reactor wall or over a part of the flow-through reactor wall.

In many cases, media are conveyed continuously or at least intermittently continuously through line sections or through the flow-through reactor in order to process larger quantities than the flow-through reactor contents with NFLUS. In such a case, the media are conveyed through the vessel by a pressure difference, e.g. between flow-through reactor inlet pressure and flow-through reactor outlet pressure. This pressure difference can be produced by using pumps, such as centrifugal pumps, or positive displacement pumps, gear pumps, screw eccentric pumps, peristaltic pumps, piston pumps, or diaphragm pumps upstream of the inlet or downstream of the outlet or within the flow-through reactor, among others. Alternatively, the vessel system upstream of the inlet can be pressurized, e.g., by gas pressure, or the vessel system downstream of the outlet can be pressurized with a lower pressure, e.g., a vacuum (or vice versa). In addition, conveying by means of a height gradient is possible.

If such a pressure difference exists between the inlet and outlet, the flowable medium can be moved through the line section or through the flow-through reactor. To regulate the flow velocity and/or the line or flow-through reactor internal pressure, the line cross-section can be varied within the vessel system upstream of the inlet and/or downstream of the outlet. For this purpose, valves, e.g. ball valves, gate valves, rotary valves, needle valves or pinch valves, preferably pinch valves, are preferably used. These can be operated or controlled manually, electrically, pneumatically or hydraulically, for example. If the line cross-section is to be regulated depending on an internal pressure measured in the system, such valves require regulation and control technology. This can be analog or digital regulation, for example. These valve systems used have considerable disadvantages for use with NFLUS.

If the flowable material flows through the flow-through reactor, the path through the flow-through reactor or the residence time in the flow-through reactor may vary for individual components or subsets of the flowable medium. In particular, if the distribution of the energy introduced into the flow-through reactor is inhomogeneous, this can lead to significant variations in the change in properties induced in the flowable material by the energy introduced into the flow-through reactor.

The invention is based on the task of providing a device and a method with which the flow of the flowable medium through the flow-through reactor can be influenced in a simple manner and with little control effort. In particular, the device according to the invention or the method according to the invention are intended to influence the flow of the flowable medium flowing through the flow-through reactor in such a way that, in the case of an inhomogeneous energy distribution in the flow-through reactor, a large part of the flowable medium flowing through the flow-through reactor flows through the zones of high energy intensity, preferably a mechanical energy intensity.

According to the invention, the task is solved by a device and a method according to the independent patent claims. Suitable embodiments are the subject of the subclaims.

The device according to the invention for influencing the flow of a flowable medium through a flow-through reactor, which has at least one inlet opening through which a flowable medium can flow into the flow-through reactor and at least one outlet opening through which a flowable medium can flow out of the flow-through reactor, comprises at least one energy source which is adapted to change at least one property of the flowable medium flowing through the flow-through reactor by introducing energy, the intensity of which is distributed non-uniformly in the volume of the flow-through reactor. Further, the device comprises at least one mechanical component positioned in the flow-through reactor and adapted to influence the flow of the flowable medium flowing through the flow-through reactor such that a majority of the flowable medium flowing through the flow-through reactor flows through the zones of high energy intensity generated by the energy source. Consequently, the flow of a flowable medium flowing through the flow-through reactor can be varied, at least in sections, on the path from the inlet opening through the flow-through reactor to the outlet opening. The mechanical component or positioned mechanical component positioned in the flow-through reactor to affect the flow of the flowable medium flowing through the flow-through reactor are collectively referred to as the mechanical component.

The mechanical component is preferably fixedly mounted in the flow-through reactor so that its position, orientation, and shape (relative to the flow-through reactor) remain unchanged during operation of the device The mechanical component may be at least sectionally round, oval, rectangular, polygonal, spiral, helical, or screw-shaped, preferably spiral, helical, or screw-shaped.

A spiral, helical, or screw-shaped mechanical component may have a constant pitch or a non-constant pitch, preferably a non-constant pitch.

The constant or the non-constant pitch of a spiral, helical, or screw-shaped mechanical component can be between 10 millimeters and 1000 millimeters, preferably between 50 millimeters and 500 millimeters.

Preferably, the mechanical component is arranged to cause an at least partially spiral movement of the flowable medium flowing through the flow-through reactor.

Also preferably, the mechanical component has apertures, cutouts or openings in which one or more mechanical energy sources are positioned. The mechanical energy sources are particularly preferably rod-shaped.

The mechanical component may be rigid or elastic, preferably rigid. The mechanical component can be made of, among other things, metal, plastic, glass, ceramic or composite materials, preferably metal, e.g. stainless steel.

The mechanical component can be made of sheet metal. The sheet metal can have a thickness between 0.05 millimeters and 100 millimeters, preferably between 1 millimeter and 20 millimeters, e.g. 2 millimeters thick.

The mechanical component can be positioned largely concentric to the flow-through reactor. Arrangements other than concentric are possible.

A fluid pressure of the flowable medium in the inner space of the flow-through reactor is preferably varied due to the flow influence caused by the mechanical component.

In a preferred embodiment, a control valve for increasing the pressure of the flowable medium exiting the flow-through reactor by reducing a cross-sectional area of the line is provided on an outlet side of the flow-through reactor.

In another preferred embodiment, the energy introduced into the flow-through reactor from the energy source is mechanical energy in the form of low-frequency power ultrasonic oscillations (NFLUS oscillations).

The energy source preferably comprises at least two, and more preferably at least three, NFLUS resonators arranged to introduce mechanical energy into the flow-through reactor in the form of low-frequency power ultrasonic vibrations (NFLUS vibrations). Two of the NFLUS resonators may be non-parallel aligned to one another and/or positioned off-center. At least two of the NFLUS resonators may be arranged to introduce mechanical energy into the flow-through reactor in the form of low-frequency power ultrasonic vibrations (NFLUS vibrations) of at least 1000 watts each, in particular 3000 watts each.

In another preferred embodiment, at least one inlet opening is positioned near the top edge of the flow-through reactor.

The flowable medium can preferably flow into the flow-through reactor largely tangentially through at least one inlet opening. Also preferably, at least one outlet opening is positioned near the bottom edge of the flow-through reactor.

In another preferred embodiment, the flow-through reactor has exactly one inlet opening through which a flowable medium can flow into the flow-through reactor and exactly one outlet opening through which a flowable medium can flow out of the flow-through reactor.

A media pressure in the flow-through reactor is preferably between 1.1 and 10 bar absolute.

Another aspect relates to a method for influencing the flow of a flowable medium through a flow-through reactor having at least one inlet opening through which a flowable medium can flow into the flow-through reactor and at least one outlet opening through which a flowable medium can flow out of the flow-through reactor, into which energy is introduced by means of at least one energy source for changing at least one property of the flowable medium flowing through the flow-through reactor and the intensity of which is non-uniformly distributed in the volume of the flow-through reactor. The flow of the flowable medium flowing through the flow-through reactor is influenced by at least one mechanical component positioned in the flow-through reactor in such a way that a majority of the flowable medium flowing through the flow-through reactor flows through the zones of high energy intensity generated by means of the energy source.

The additional features and advantages of the device according to the invention can be used analogously for the method according to the invention.

### POSSIBLE EMBODIMENTS

Possible embodiments of the device and method according to the invention are described below. Other embodiments than those described are possible.

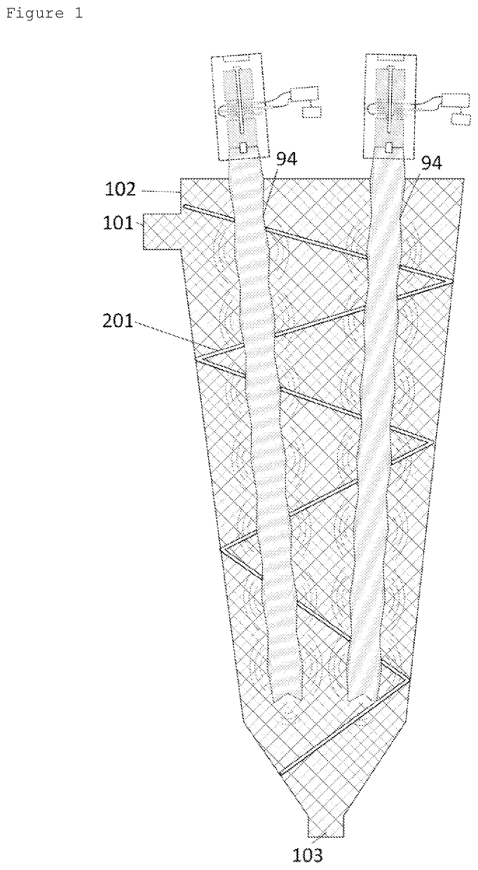

FIG. 1a schematic representation of a device according to the invention according to a first embodiment;

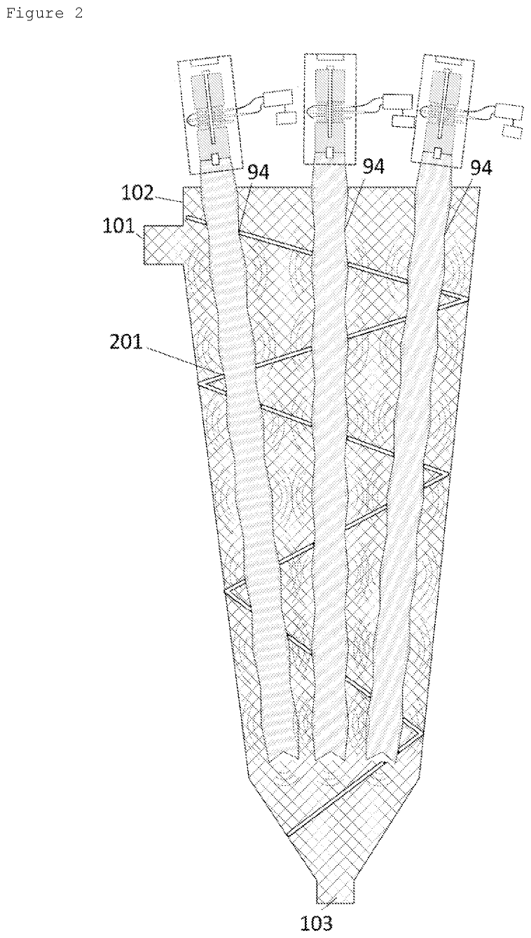

FIG. 2a schematic representation of a device according to the invention according to a second embodiment; and

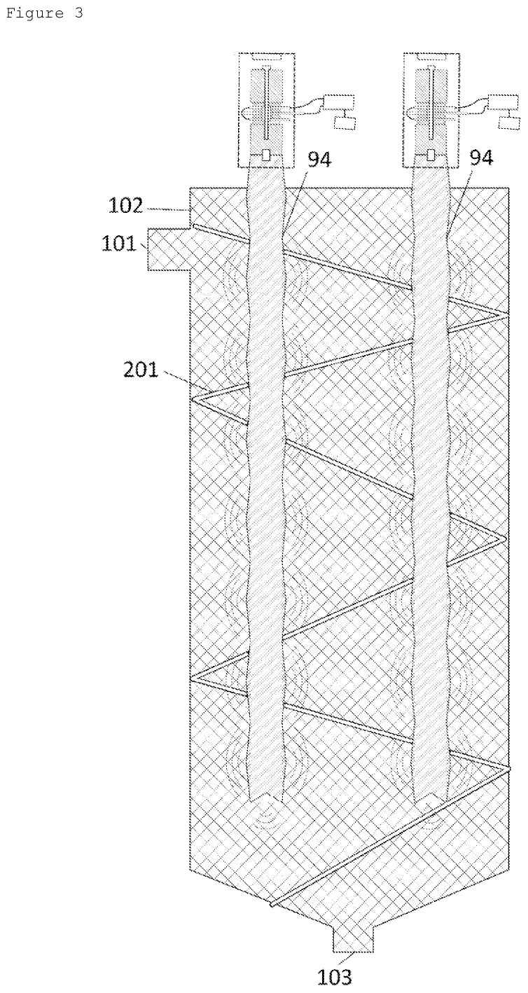

FIG. 3A schematic representation of a device according to the invention according to a third embodiment.

FIG. 1 shows a possible embodiment according to a first embodiment. In this embodiment, a flowable medium with a variable flow-through rate of 15 to 25 liters per minute is pumped into a rigid, largely funnel-shaped, welded stainless steel flow-through reactor 102 with a volume of 100 liters, which has an inlet opening 101 with an opening cross section of 70 square centimeters, through which a flowable medium is pumped into the flow-through reactor 102 by means of a worm eccentric pump, and an outlet opening 103 with an opening cross section of 100 square centimeters, through which the flowable medium flows out of the flow-through reactor 102, by means of two rod-shaped, rotationally symmetrical, off-center placed NFLUS resonators 94 of titanium grade 5, which are not aligned parallel to one another, which are driven by means of piezoelectric elements 96, mechanical energy in the form of NFLUS vibrations with a frequency of 20 kilohertz and a radial amplitude of 10 micrometers (peak-peak) is introduced into the flowable medium flowing through the flow-through reactor 102. To regulate the flow-through reactor internal pressure, a line cross-section within the vessel system downstream of the outlet is varied via a pneumatic pinch valve. The flowable medium flowing through the flow-through reactor 102 is a pulpy aqueous medium having a viscosity of 60000 centipoise and containing comminuted plant matter. The mechanical power transmitted from the NFLUS resonators 94 to the flowable medium during operation is 3000 watts per NFLUS resonator 94. The NFLUS vibrations create cavitation in the flowable medium flowing through the flow-through reactor 102 which causes a change in the particle size of the particles in the flowable medium. The mechanical energy introduced results in heating of the flowable medium. The intensity of the energy introduced into the flow-through reactor 102 is not uniform, i.e. inhomogeneously distributed. The flow of the flowable medium in the flow-through reactor 102 is influenced by a mechanical component 201 positioned in the flow-through reactor 102 such that a majority of the flowable medium flowing through the flow-through reactor 102 passes through the zones of high energy intensity. The mechanical component 201 is made of 2 millimeter stainless steel plate and is fixedly mounted concentrically within the flow-through reactor 102 and does not change position, orientation, or shape during operation. The mechanical component 201 has openings, or cutouts, for positioning the NFLUS resonators 94. The mechanical component 201 does not contact the NFLUS resonators 94. The mechanical component 201 is at least sectionally spiral or helical, with a variable pitch between 80 millimeters and 250 millimeters. The pitch increases from top to bottom. The mechanical component 201 causes the flowable medium flowing through the flow-through reactor 102 to move at least partially in a spiral. Therefore, on its way from the inlet opening 101 to the outlet opening 103, most of the flowable medium passes through the high intensity zones surrounding the NFLUS resonators 94. The media pressure in the flow-through reactor 102 is between 1.1 and 8 bar absolute.

FIG. 2 shows a possible embodiment according to a second embodiment. In this embodiment, a flowable medium with a variable flow rate of 20 to 50 liters per minute is pumped into a rigid, largely funnel-shaped welded stainless steel flow-through reactor 102 with a volume of 150 liters, which has an inlet opening 101 with an opening cross section of about 60 square centimeters, through which a flowable medium is pumped into the flow-through reactor 102 by means of a positive displacement pump, and an outlet opening 103 with an opening cross section of about 80 square centimeters through which the flowable medium flows out of the flow-through reactor 102, mechanical energy in the form of NFLUS vibrations with a frequency of 21 kilohertz and a radial amplitude of 2 micrometers (peak-peak) is introduced into the flowable medium flowing through the flow-through reactor 102 by means of three rod-shaped, rotationally symmetrical NFLUS resonators 94 made of stainless steel, which are not aligned parallel to one another and are driven by means of piezoelectric elements 96. The flow direction of the flowable medium through the flow-through reactor 102 is reversed at least temporarily. To regulate the internal pressure of the flow-through reactor, a line cross-section within the vessel system downstream of the outlet is varied via a pneumatic pinch valve. The flowable medium flowing through the flow-through reactor 102 is a pasty medium having a viscosity of 100000 centipoise and containing solid particles. The mechanical power transmitted from the NFLUS resonators to the flowable medium during operation is 2500 watts per NFLUS resonator. The NFLUS vibrations generate high frequency pressure fluctuations in the flowable medium flowing through the flow-through reactor 102, which cause disagglomeration of the particles in the flowable medium. The mechanical energy introduced also results in heating of the flowable medium. The intensity of the energy introduced into the flow-through reactor 102 is nonuniform, i.e. not homogeneously distributed. The flow of the flowable medium in the flow-through reactor 102 is influenced by a mechanical component 201 positioned in the flow-through reactor 102 such that a majority of the flowable medium flowing through the flow-through reactor 102 passes through the zones of high energy intensity. The mechanical component 201 is fabricated from 2 millimeter steel plate by bending and welding and is fixedly mounted concentrically within the flow-through reactor 102 and does not change position, orientation, or shape during operation. The mechanical component 201 has openings, or cutouts, for positioning the NFLUS resonators 94, and the mechanical component 201 does not contact the NFLUS resonators 94. The mechanical component 201 is at least sectionally spiral or helical with a variable pitch between 50 millimeters and 200 millimeters. The pitch increases from the top to the bottom. The mechanical component 201 causes the flowable medium flowing through the flow-through reactor 102 to move at least partially in a spiral. Therefore, on its way from the inlet opening 101 to the outlet opening 103, most of the flowable medium passes through the high intensity zones surrounding the NFLUS resonators 94. The media pressure in the flow-through reactor 102 is between 3 and 7 bar absolute.

FIG. 3 shows a possible embodiment according to a third embodiment. In this embodiment, in a rigid, largely cylindrical plastic flow-through reactor 102 with a volume of 500 liters, which has an inlet opening 101 attached tangentially to the flow-through reactor 102, through which a flowable medium is pumped into the flow-through reactor 102 by means of a centrifugal pump at a variable flow rate of 10 to 100 liters per minute, and an outlet opening 103, through which the flowable medium flows out of the flow-through reactor 102, mechanical energy in the form of NFLUS vibrations having a frequency of 18 kilohertz and a longitudinal amplitude of 30 micrometers (peak-peak) is introduced into the flowable medium flowing through the flow-through reactor 102 by means of two rod-shaped, rotationally symmetrical, off-centered NFLUS resonators 94 made of titanium grade 5, which are aligned parallel to each other and are driven by means of piezoelectric elements 96. To regulate the flow-through reactor internal pressure, a line cross-section within the vessel system downstream of the outlet is varied via a ball valve. The flowable medium flowing through the flow-through reactor 102 is an aqueous dispersion having a viscosity of 5000 centipoise, which contains nanomaterials. The mechanical power transmitted from the NFLUS resonators 94 to the flowable medium during operation is 8000 watts per NFLUS resonator 94. The NFLUS vibrations create cavitation in the flowable medium flowing through the flow-through reactor 102, which causes a change in the specific particle surface area of the nanomaterials in the flowable medium. The mechanical energy introduced additionally causes heating of the flowable medium. The intensity of the energy introduced into the flow-through reactor 102 is unevenly distributed; it is higher near the NFLUS resonator surface. The flow of the flowable medium in the flow-through reactor 102 is influenced by a mechanical component 201 positioned in the flow-through reactor 102 such that a majority of the flowable medium flowing through the flow-through reactor 102 passes through the zones near the resonator surfaces. The mechanical component 201 is made of 2 millimeter stainless steel sheet and is fixedly mounted in the flow-through reactor 102 and does not change position or orientation during operation. The shape of the mechanical component 201 changes as the flowable medium flows against the mechanical component 201. The mechanical component 201 has openings, or apertures, for positioning the NFLUS resonators 94. The mechanical component 201 does not contact the NFLUS resonators 94. The mechanical component 201 is at least partially spiralor helical with a variable pitch between 80 millimeters and 250 millimeters. The mechanical component 201 causes at least partial spiral motion of the flowable medium flowing through the flow-through reactor 102. Therefore, on its way from the inlet opening 101 to the outlet opening 103, most of the flowable medium passes through the high intensity zones surrounding the NFLUS resonators 94. The media pressure in the flow-through reactor 102 is between 1.1 and 2 bar absolute.

One aspect relates to a device and/or a method for influencing the flow of a flowable medium through a flow-through reactor, which has at least one inlet opening through which a flowable medium can flow into the flow-through reactor and at least one outlet opening, through which a flowable medium can flow out of the flow-through reactor, into which energy is introduced by means of at least one energy source in order to change at least one property of the flowable medium flowing through the flow-through reactor, and the intensity of which energy is distributed non-uniformly in the volume of the flow-through reactor, characterized in that:the flow of the flowable medium flowing through the flow-through reactor is influenced by at least one mechanical component positioned in the flow-through reactor in such a way that most of the flowable medium flowing through the flow-through reactor flows through the zones of high energy intensity.

According to a further aspect, the device and/or method are characterized in that the flow-through reactor has a volume of 0.2 liters to 5000 liters.

According to a further aspect, the device and/or the method are characterized in that at least one property of the flowable medium, other than temperature, flowing through the flow-through reactor is changed.

According to a further aspect, the device and/or the method are characterized in that at least the particle size distribution of the flowable medium flowing through the flow-through reactor is changed.

According to a further aspect, the device and/or method are characterized in that the mechanical component positioned in the flow-through reactor for influencing the flow of the flowable medium is fixedly mounted and does not change its position, orientation and shape during operation.

According to a further aspect, the device and/or method are characterized in that the mechanical component positioned in the flow-through reactor for influencing the flow of the flowable medium is at least sectionally spiral, helical, or screw-shaped.

According to a further aspect, the device and/or the method are characterized in that a mechanical component positioned in the flow-through reactor for influencing the flow of the flowable medium, which is at least sectionally spiral, helical, or screw-shaped, has a non-constant pitch of between 50 millimeters and 500 millimeters.

According to a further aspect, the device and/or method are characterized in that a mechanical component positioned in the flow-through reactor for influencing the flow of the flowable medium, which is at least sectionally spiral, helical, or screw-shaped, has a constant pitch of between 50 millimeters and 500 millimeters.

According to a further aspect, the device and/or method are characterized in that the mechanical component positioned in the flow-through reactor for influencing the flow of the flowable medium causes an at least partially spiral motion of the flowable medium flowing through the flow-through reactor.

According to a further aspect, the device and/or method are characterized in that the mechanical component positioned in the flow-through reactor comprises apertures, cutouts or openings in which one or more rod-shaped mechanical energy sources are positioned.

According to a further aspect, the device and/or method are characterized in that the fluid pressure of the flowable medium in the inner space of the flow-through reactor varies due to the flow influence caused by the mechanical component positioned in the flow-through reactor.

According to a further aspect, the device and/or method are characterized in that a control valve is provided on the outlet side of the flow-through reactor, which can increase the pressure of the flowable medium flowing out of the flow-through reactor by reducing the line cross-section.

According to a further aspect, the device and/or method are characterized in that the energy introduced into the flow-through reactor is mechanical energy in the form of low frequency power ultrasonic vibrations (NFLUS vibrations).

According to a further aspect, the device and/or method are characterized in that mechanical energy in the form of low frequency power ultrasonic oscillations (NFLUS oscillations) is introduced into the flow-through reactor via at least two NFLUS resonators.

According to a further aspect, the device and/or method are characterized in that mechanical energy is introduced into the flow-through reactor in the form of low frequency power ultrasonic vibrations (NFLUS vibrations) via at least three NFLUS resonators.

According to a further aspect, the device and/or method are characterized in that mechanical energy in the form of low frequency power ultrasonic vibrations (NFLUS vibrations) is introduced into the flow-through reactor via at least two non-parallel aligned NFLUS resonators.

According to a further aspect, the device and/or method are characterized in that mechanical energy in the form of low frequency power ultrasonic vibrations (NFLUS vibrations) is introduced into the flow-through reactor via at least two off-center placed NFLUS resonators. According to a further aspect, the device and/or method are characterized in that mechanical energy in the form of low frequency power ultrasonic vibrations (NFLUS vibrations) is introduced into the flow-through reactor via at least two NFLUS resonators of at least 1000 watts each.

According to a further aspect, the device and/or method are characterized in that mechanical energy in the form of low frequency power ultrasonic vibrations (NFLUS vibrations) is introduced into the flow-through reactor via at least two NFLUS resonators of at least 3000 watts each.

According to a further aspect, the device and/or method are characterized in that at least one inlet opening is positioned near the top edge of the flow-through reactor.

According to a further aspect, the device and/or method are characterized in that the flowable medium flows into the flow-through reactor substantially tangentially through at least one inlet opening.

According to a further aspect, the device and/or method are characterized in that at least one outlet opening is positioned near the bottom edge of the flow-through reactor.

According to a further aspect, the device and/or method are characterized in that the flow-through reactor has exactly one inlet opening through which a flowable medium can flow into the flow-through reactor and exactly one outlet opening through which a flowable medium can flow out of the flow-through reactor. According to a further aspect, the device and/or method are characterized in that the media pressure in the flow-through reactor is between 1.1 and 10 bar absolute.

The preceding aspects can be combined with each other in any way.

1. The device for influencing the flow of a flowable medium through a flow-through reactor, which has at least one inlet opening through which a flowable medium can flow into the flow-through reactor and at least one outlet opening through which a flowable medium can flow out of the flow-through reactor, comprising:
at least one energy source adapted to change at least one property of the flowable medium flowing through the flow-through reactor by introducing energy, the intensity of which is non-uniformly distributed in the volume of the flow-through reactor,
wherein
at least one mechanical component positioned in the flow-through reactor and adapted to influence the flow of the flowable medium flowing through the flow-through reactor such that a majority of the flowable medium flowing through the flow-through reactor flows through the zones of high energy intensity generated by the energy source.

2. The device according to claim 1, wherein the flow-through reactor has a volume of 0.2 liters to 5000 liters.

3. The device according to claim 1, wherein the energy source is adapted to change at least one property, other than temperature, of the flowable medium flowing through the flow-through reactor.

4. The device according to claim 1, wherein the energy source is adapted to change at least the particle size distribution of the flowable medium flowing through the flow-through reactor.

5. The device in claim 1, wherein the mechanical component is fixedly mounted so that its position, orientation and shape remain unchanged during operation of the device.

6. The device in claim 1, wherein the mechanical component is at least sectionally spiral, helical, or screw-shaped.

7. The device according to claim 6, wherein the mechanical component has a non-constant pitch between 50 millimeters and 500 millimeters.

8. The device according to claim 6, wherein the mechanical component has a constant pitch between 50 millimeters and 500 millimeters.

9. The device according to claim 1, wherein the mechanical component is adapted to cause an at least partially spiral movement of the flowable medium flowing through the flow-through reactor.

10. The device according to claim 1, wherein the mechanical component comprises apertures, cutouts or openings in which one or more rod-shaped mechanical energy sources are positioned.

11. The device according to claim 1, wherein a fluid pressure of the flowable medium in the inner sparce of the flow-through reactor varies due to the flow influence caused by the mechanical component.

12. The device according to claim 1, wherein a control valve for increasing the pressure of the flowable medium flowing out of the flow-through reactor by reducing a line cross-section is provided on an outlet side of the flow-through reactor.

13. The device according to claim 1, wherein the energy introduced into the flow-through reactor from the energy source is mechanical energy in the form of low frequency power ultrasonic vibrations (NFLUS vibrations).

14. The device of claim 13, wherein the energy source comprises at least two NFLUS resonators adapted to introduce mechanical energy into the flow-through reactor in the form of low frequency power ultrasonic vibrations (NFLUS vibrations).

15. The device of claim 14, wherein the energy source comprises at least three NFLUS resonators adapted to introduce mechanical energy into the flow-through reactor in the form of low frequency power ultrasonic vibrations (NFLUS vibrations).

16. The device of claim 14, wherein the energy source comprises at least two non-parallel aligned NFLUS resonators adapted to introduce mechanical energy into the flow-through reactor in the form of low frequency power ultrasonic vibrations (NFLUS vibrations).

17. The device according to claim 14, wherein the energy source comprises at least two off-center placed NFLUS resonators adapted to introduce mechanical energy into the flow-through reactor in the form of low frequency power ultrasonic vibrations (NFLUS vibrations).

18. The device according to claim 14, wherein the energy source comprises at least two NFLUS resonators adapted to introduce mechanical energy into the flow-through reactor in the form of low frequency power ultrasonic vibrations (NFLUS vibrations) of at least 1000 watts each.

19. The device of claim 18, wherein at least two NFLUS resonators are adapted to introduce mechanical energy into the flow-through reactor in the form of low frequency power ultrasonic vibrations (NFLUS vibrations) of at least 3000 watts each.

20. The device according to claim 1, wherein at least one inlet opening is positioned near the top edge of the flow-through reactor.

21. The device according to claim 1, wherein the flowable medium can flow largely tangentially into the flow-through reactor through at least one inlet opening.

22. The device according to claim 1, wherein at least one outlet opening is positioned near the lower edge of the flow-through reactor.

23. The device according to claim 1, wherein the flow-through reactor has exactly one inlet opening through which a flowable medium can flow into the flow-through reactor and exactly one outlet opening through which a flowable medium can flow out of the flow-through reactor.

24. The device according to claim 1, wherein a media pressure in the flow-through reactor is between 1.1 and 10 bar absolute.

25. Method for influencing the flow of a flowable medium through a flow-through reactor, which has at least one inlet opening, through which a flowable medium can flow into the flow-through reactor, and at least one outlet opening, through which a flowable medium can flow out of the flow-through reactor, into which energy is introduced by means of at least one energy source for changing at least one property of the flowable medium flowing through the flow-through reactor and the intensity of which is distributed non-uniformly in the volume of the flow-through reactor,
wherein
the flow of the flowable medium flowing through the flow-through reactor is influenced by at least one mechanical component positioned in the flow-through reactor such that a majority of the flowable medium flowing through the flow-through reactor flows through the zones of high energy intensity generated by means of the energy source.
